(19) United States
(12) Patent Application Publication
(10) Pub. No.: US 2025/0155738 A1
(43) Pub. Date: May 15, 2025

(54) OPTICAL DEVICE, OPTICAL TRANSMITTER, AND OPTICAL TRANSCEIVER

(71) Applicant: FUJITSU OPTICAL COMPONENTS LIMITED, Kawasaki-shi (JP)

(72) Inventor: Masaki SUGIYAMA, Kawasaki (JP)

(73) Assignee: FUJITSU OPTICAL COMPONENTS LIMITED, Kawasaki-shi (JP)

(21) Appl. No.: 18/910,343

(22) Filed: Oct. 9, 2024

(30) Foreign Application Priority Data
Nov. 13, 2023 (JP) 2023-193130

(51) Int. Cl. G02F 1/035; H04B 10/40

(52) U.S. Cl. CPC G02F 1/0356; H04B 10/40

(57) ABSTRACT

An optical device includes a first chip and a second chip that has a material having a high electro-optic effect. The first chip includes a first waveguide propagating a beam from a first port, a first branched waveguide propagating the beam from the first waveguide, a turned-back parallel waveguide connecting with the first branched waveguide, and a first parallel waveguide propagating the beam from the turned-back parallel waveguide. The first chip includes a second waveguide propagating a beam from a second port, a second branched waveguide propagating the beam from the second waveguide, and a phase adjustor adjusting a phase of the beam propagating in the first branched waveguide. The second chip includes a second parallel waveguide coupling the first parallel waveguide and the second branched waveguide, and a phase modulator adjusting a phase of the beam propagating in the second parallel waveguide.

### CROSS-REFERENCE TO RELATED APPLICATION

This application is based upon and claims the benefit of priority of the prior Japanese Patent Application No. 2023-193130, filed on Nov. 13, 2023, the entire contents of which are incorporated herein by reference.

### FIELD

The embodiments discussed herein are related to an optical device, an optical transmitter, and an optical transceiver.

### BACKGROUND

A conventional optical modulator includes, for example, waveguides that are provided on a substrate, and signal electrodes and ground electrodes that are disposed near the waveguides, the electric field is generated in the waveguide when a voltage is applied to the signal electrode, the electric field in the waveguide changes the refractive index of the waveguide, and the phase of light changes. The waveguides constitute a Mach-Zehnder interferometer, and a difference between the phases of light of the waveguides changes a light output.

The optical modulator is, for example, a Mach-Zehnder modulator. FIG. 6 is a schematic plan view illustrating an example of a conventional optical modulator 200. The optical modulator 200 includes, for example, a thin film Lithium Niobate (LN: LiNbO₃) chip 201, one MicroLens Array (MLA) 202, and one Polarization Rotator (PR) 203. Furthermore, the optical modulator 200 includes one Polarization Beam Combiner (PBC) 204 and an optical fiber array 205.

The thin film LN chip 201 includes a first port 201A, a first waveguide 211, a turned-back waveguide 212, one first branched portion 213, and two first branched waveguides 214. The thin film LN chip 201 includes two second branched portions 215, four second branched waveguides 216, and four third branched portions 217. The thin film LN chip 201 includes eight third branched waveguides 218, four Radio Frequency (RF) modulation units 230, four first Direct Current (DC) modulation units 240, and four first multiplexing units 219. The thin film LN chip 201 includes four fourth branched waveguides 220, two second DC modulation units 250, a second multiplexing unit 221, two output waveguides 222, and a second port 201B.

The first port 201A is a port that is disposed at one end of the thin film LN chip 201, is connected with the MLA 202, and is connected with the first waveguide 211. The first waveguide 211 is, for example, an LN waveguide that propagates a signal light beam from the first port 201A. An input end of the first waveguide 211 is exposed to one end surface of the thin film LN chip 201. The first waveguide 211 outputs the signal light beam from the input end to the turned-back waveguide 212. The turned-back waveguide 212 is, for example, an LN waveguide that propagates the signal light beam from the first waveguide 211.

The first branched portion 213 branches the signal light beam from the turned-back waveguide 212 into the two first branched waveguides 214. The first branched waveguides 214 are, for example, LN waveguides that propagate the signal light beams from the first branched portion 213. The second branched portion 215 branches the signal light beam from the first branched waveguide 214 into the two second branched waveguides 216. The second branched waveguides 216 are, for example, LN waveguides that propagate the signal light beams from the second branched portions 215. The third branched portion 217 branches the signal light beam from the second branched waveguide 216 into the two third branched waveguides 218 in the RF modulation unit 230.

The RF modulation unit 230 is a phase modulation unit that modulates signal light beams propagating through the two third branched waveguides 218 at a high speed. The RF modulation unit 230 includes the two third branched waveguides 218 that are disposed in parallel, a plurality of RF electrodes 231 that are disposed in parallel to the two third branched waveguides 218, and an RF driver 232 that inputs a high-frequency signal to the RF electrodes 231. Furthermore, the RF modulation unit 230 includes an RF termination 233 that terminates high-frequency signals of the RF electrodes 231, and electrode wires 234 that electrically connect the RF electrodes 231 and the RF driver 232. The two third branched waveguides 218 are LN waveguides. When, for example, a high-frequency signal having a band of several 10 GHz is input from the RF driver 232 to the RF electrode 231, the RF modulation unit 230 can modulate signal light beams propagating through the third branched waveguides 218 at a high speed according to the high-frequency signal.

The first DC modulation unit 240 includes the two third branched waveguides 218 that are disposed in parallel, and a plurality of first DC electrodes 241 that are disposed in parallel on the two third branched waveguides 218. The two third branched waveguides 218 are, for example, LN waveguides. The first DC modulation unit 240 is a phase adjustment unit that connects the two third branched waveguides 218 in the RF modulation unit 230 and the two third branched waveguides 218 in the first DC modulation unit 240, and modulates signal light beams propagating through the two third branched waveguides 218 in the first DC modulation unit 240. When a bias voltage is applied to the first DC electrode 241, the first DC modulation unit 240 adjusts a bias for turning on/off the signal light beams propagating through the third branched waveguides 218 according to ON/OFF of the bias voltage. As a result, the bias for turning on/off the signal light beams propagating through the third branched waveguides 218 is adjusted, so that it is possible to adjust the phases of the signal light beams propagating through the third branched waveguides 218. The first multiplexing unit 219 multiplexes the signal light beams from the two third branched waveguides 218 in the first DC modulation unit 240, and outputs the multiplexed signal light beam to the fourth branched waveguides 220.

The second DC modulation unit 250 includes the two fourth branched waveguides 220 that are disposed in parallel, and a second DC electrode 251 that is disposed on the two fourth branched waveguides 220. The two fourth branched waveguides 220 are, for example, LN waveguides. The second DC modulation unit 250 is a phase adjustment unit that connects the two first multiplexing units 219 and the two fourth branched waveguides 220 in the second DC modulation unit 250, and modulates the signal light beams propagating through the two fourth branched waveguides 220 in the second DC modulation unit 250. When a bias voltage is applied to the second DC electrode 251, the second DC modulation unit 250 adjusts a bias for turning on/off signal light beams propagating through the fourth branched waveguides 220 according to ON/OFF of the bias voltage. As a result, the bias for turning on/off the signal light beams propagating through the fourth branched waveguides 220 is adjusted, so that it is possible to adjust the phases of the signal light beams propagating through the fourth branched waveguides 220. The second DC modulation unit 250 modulates the signal light beams propagating through the fourth branched waveguides 220, and outputs the modulated signal light beams to the second multiplexing unit 221. The second multiplexing unit 221 multiplexes the modulated signal light beams from the two fourth branched waveguides 220 in the second DC modulation unit 250, and outputs the multiplexed signal light beam to the output waveguide 222.

The one second multiplexing unit 221 multiplexes the signal light beams from the two fourth branched waveguides 220 in the one second DC modulation unit 250, and outputs the multiplexed signal light beam to the one output waveguide 222. The other second multiplexing unit 221 multiplexes the signal light beams from the two fourth branched waveguides 220 in the other second DC modulation unit 250, and outputs the multiplexed signal light beam to the other output waveguide 222. The second port 201B is disposed at one end of the thin film LN chip 201, and includes a port that is connected with the one output waveguide 222 and a port that is connected with the other output waveguide 222.

The output waveguides 222 are, for example, LN waveguides that propagate the signal light beams from the second multiplexing unit 221. The second port 201B connected with output ends of the output waveguides 222 is exposed to the one end surface of the thin film LN chip 201. The MLA 202 is an optical component that optically connects the one output waveguide 222 and the PR 203 and optically connects the other output waveguide 222 and the PBC 204. The MLA 202 optically connects the first waveguide 211 and an optical fiber 205A on an input side in the optical fiber array 205. The MLA 202 condenses in the first waveguide 211 the signal light beam from the optical fiber 205A on the input side in the optical fiber array 205. The MLA 202 condenses in the PR 203 the signal light beam from the one output waveguide 222, and condenses in the PBC 204 the signal light beam from the other output waveguide 222.

The PR 203 performs polarization-rotation on the signal light beam from the one output waveguide 222 via the MLA 202, and outputs the polarization-rotated signal light beam to the PBC 204. The PBC 204 polarization-multiplexes the polarization-rotated signal light beam from the PR 203 and the signal light beam from the other output waveguide 222 via the MLA 202, and outputs the polarization-multiplexed signal light beam to an optical fiber 205B on an output side of the optical fiber array 205.

By inputting a high-frequency signal output from the RF driver 232 to the RF electrodes 231 through the electrode wires 234, and causing the high-frequency signal to propagate in the same direction as the signal light beams propagating through the third branched waveguides 218, the optical modulator 200 can modulate the signal light beams.

Patent Literature 1: U.S. Patent Application Publication No. 2023/0152660

Patent Literature 2: U.S. Patent Application Publication No. 2021/0373412

Patent Literature 3: International Publication Pamphlet No. WO 2015/012213

Patent Literature 4: Japanese Laid-open Patent Publication No. 2012-163876

The sizes of the first DC modulation unit 240 and the second DC modulation unit 250 become large in the optical modulator 200, and therefore the size of the thin film LN chip 201 becomes large. Furthermore, the MLA 202, the PR 203, and the PBC 204 are individual components, and therefore the size of a package of the thin film LN chip 201 becomes large.

Hence, it is demanded to miniaturize a chip size of the optical modulator by integrating the first DC modulation units 240, the second DC modulation units 250, the PR 203, and the PBC 204 on a Silicon Photonics (SiPh) chip and mounting a thin film LN chip on the SiPh chip.

### SUMMARY

According to an aspect of an embodiment, an optical device includes a first chip and a second chip. The first chip includes a first port and a second port. The second chip is disposed on the first chip and has a material having a higher electro-optic effect than an electro-optic effect of the first chip. The first chip includes a first waveguide, a first branched waveguide, a turned-back parallel waveguide, a first parallel waveguide, a second waveguide, a second branched waveguide, and a phase adjustor. The first waveguide is connected with the first port and propagates a signal light beam from the first port. The first branched waveguide is connected with the first waveguide and has a branched structure that propagates the signal light beam from the first waveguide. The turned-back parallel waveguide is connected with the first branched waveguide and has a turned-back structure. The first parallel waveguide is connected with the turned-back parallel waveguide and propagates the signal light beam from the turned-back parallel waveguide. The second waveguide is connected with the second port and propagates the signal light beam to the second port. The second branched waveguide is connected with the second waveguide and has a branched structure that propagates the signal light beam to the second waveguide. The phase adjustor is disposed on the first branched waveguide and adjusts a phase of the signal light beam propagating through the first branched waveguide according to a direct current electrical signal. The second chip includes a second parallel waveguide and a phase modulator. The second parallel waveguide is coupled with the first parallel waveguide on a first end surface, is coupled with the second branched waveguide on a second end surface different from the first end surface, and propagates the signal light beam from the first parallel waveguide to the second branched waveguide. The phase modulator is disposed on the second parallel waveguide, and modulates a phase of the signal light beam propagating through the second parallel waveguide according to a high-frequency signal.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is a schematic plan view illustrating an example of an optical modulator according to embodiment 1;

FIG. 2 is a schematic plan view illustrating an example of an optical modulator according to embodiment 2;

FIG. 3 is a schematic plan view illustrating an example of an optical modulator according to embodiment 3;

FIG. 4 is an explanatory view illustrating an example of an optical transceiver according to the present embodiment;

FIG. 5 is a schematic plan view illustrating an example of an optical modulator according to a comparative example; and

FIG. 6 is a schematic plan view illustrating an example of a conventional optical modulator.

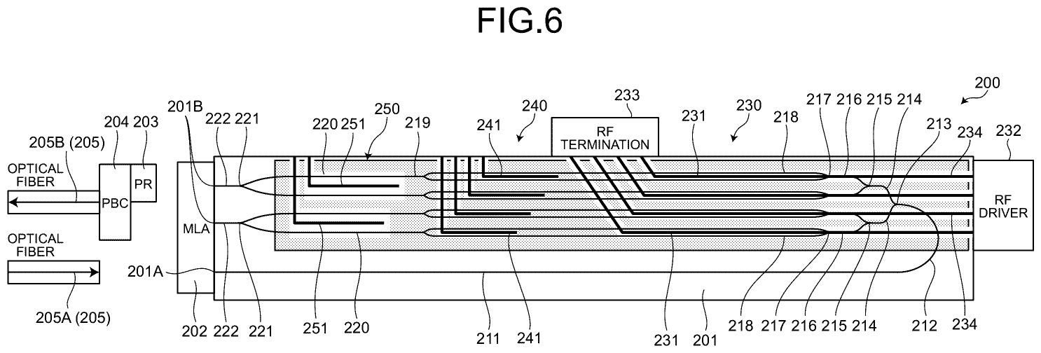

### DESCRIPTION OF EMBODIMENTS

### Comparative Example 1

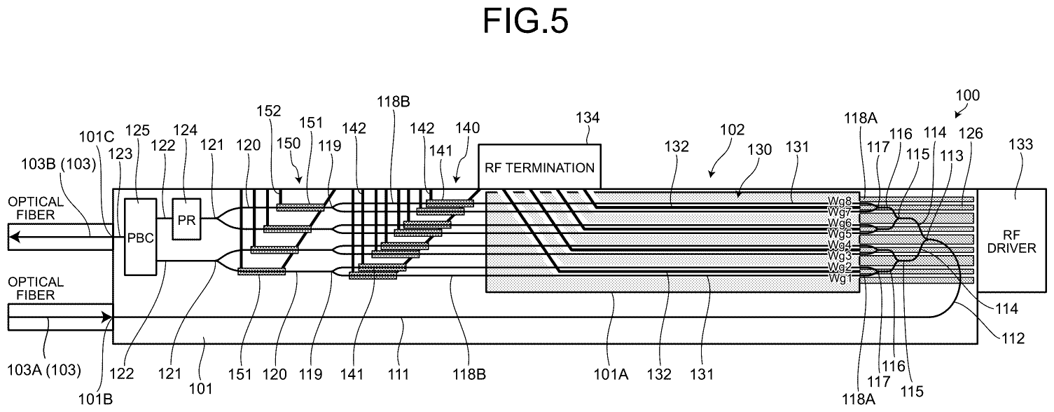

FIG. 5 is a schematic plan view illustrating an example of an optical modulator 100 according to a comparative example. The optical modulator 100 illustrated in FIG. 5 includes a SiPh chip 101 on which first DC modulation units 140 each including first heater electrodes 141 and second DC modulation units 150 each including second heater electrodes 151 are mounted. The optical modulator 100 includes a thin film Lithium Niobate (LN: LiNbO₃) chip 102 on which RF modulation units 130 each including RF electrodes 132 are mounted, and an optical fiber array 103 that includes an optical fiber 103A on an input side and an optical fiber 103B on an output side.

The SiPh chip 101 includes a Si substrate, an opening portion 101A that is opened at part of the Si substrate, a first port 101B that is disposed on one end surface, and a second port 101C that is disposed on one end surface. The opening portion 101A has a structure formed by digging part of the Si substrate by etching. The opening portion 101A is a portion at which the thin film LN chip 102 is mounted.

The SiPh chip 101 includes one first waveguide 111, a turned-back waveguide 112, one first branched portion 113, two first branched waveguides 114, two second branched portions 115, and four second branched waveguides 116. The SiPh chip 101 includes four third branched portions 117 and four third branched waveguides 118A.

The SiPh chip 101 includes eight fourth branched waveguides 118B, the four first Direct Current (DC) modulation units 140, and four first multiplexing units 119. The SiPh chip 101 includes four fifth branched waveguides 120, the two second DC modulation units 150, a second multiplexing unit 121, and two first output waveguides 122. The SiPh chip 101 includes one Polarization Rotator (PR) 124, one Polarization Beam Combiner (PBC) 125, and one second output waveguide 123.

The thin film LN chip 102 includes eight parallel waveguides 131 and the four Radio Frequency (RF) modulation units 130. The first waveguide 111 in the SiPh chip 101 is, for example, an Si waveguide that propagates a signal light beam from the first port 101B. An input end of the first waveguide 111 is coupled with the optical fiber 103A on an input side in the optical fiber array 103. The first waveguide 111 outputs the signal light beam from the first port 101B to the turned-back waveguide 112. The turned-back waveguide 112 is, for example, an Si waveguide that propagates a signal light beam from the first waveguide 111.

The first branched portion 113 branches the signal light beam from the turned-back waveguide 112 into the two first branched waveguides 114. The first branched waveguides 114 are, for example, Si waveguides that propagate signal light beams from the first branched portion 113. The second branched portion 115 branches the signal light beam from the first branched waveguide 114 into the two second branched waveguides 116. The second branched waveguides 116 are, for example, Si waveguides that propagate the signal light beam from the second branched portion 115. The third branched portion 117 branches the signal light beam from the second branched waveguides 116 into the two third branched waveguides 118A.

The RF modulation unit 130 is a phase modulation unit that modulates, at a high speed, signal light beams propagating through the parallel waveguides 131 connected with the third branched waveguides 118A. The RF modulation unit 130 includes the two parallel waveguides 131 that are disposed in parallel, a plurality of the RF electrodes 132 that are disposed in parallel to the two parallel waveguides 131, and an RF driver 133 that inputs a high-frequency signal to the RF electrodes 132. Furthermore, the RF modulation unit 130 includes an RF termination 134 that terminates the high-frequency signals of the RF electrodes 132. The two parallel waveguides 131 are LN waveguides. When high-frequency signals having bands of several 10 GHz are input from the RF driver 133 to the RF electrodes 132, for example, the RF modulation unit 130 can modulate the signal light beams propagating through the parallel waveguides 131 at a high speed according to the high-frequency signals. The SiPh chip 101 includes electrode wires 126 that electrically connect the RF electrodes 132 and the RF driver 133 in the thin film LN chip 102. Note that, for example, Al is used for the electrode wires 126.

The first DC modulation unit 140 includes the two fourth branched waveguides 118B that are disposed in parallel, a plurality of the first heater electrodes 141 that are disposed in parallel on the two fourth branched waveguides 118B, and the electrode wires 142 that are electrically connected with the first heater electrodes 141. The two fourth branched waveguides 118B are, for example, Si waveguides. The first DC modulation unit 140 is a phase adjustment unit that connects the two parallel waveguides 131 in the RF modulation unit 130 and the two fourth branched waveguides 118B in the first DC modulation unit 140, and modulates the signal light beams propagating through the two fourth branched waveguides 118B. When a current flows through the first heater electrodes 141, the first DC modulation unit 140 heats the fourth branched waveguides 118B by heat generated by the first heater electrodes 141. As a result, the thermo-optic effect changes the refractive indices of the fourth branched waveguides 118B, so that it is possible to adjust the phases of the signal light beams propagating through the fourth branched waveguides 118B. The first multiplexing unit 119 multiplexes the signal light beams from the two fourth branched waveguides 118B in the first DC modulation unit 140, and outputs the multiplexed signal light beam to the fifth branched waveguides 120.

The second DC modulation unit 150 includes the two fifth branched waveguides 120 that are disposed in parallel, the second heater electrodes 151 that are disposed on the two fifth branched waveguides 120, and the electrode wires 152 that are electrically connected with the second heater electrodes 151. The two fifth branched waveguides 120 are, for example, Si waveguides. The second DC modulation unit 150 is a phase adjustment unit that connects the two first multiplexing units 119 and the two fifth branched waveguides 120 in the second DC modulation unit 150, and modulates the signal light beams propagating through the two fifth branched waveguides 120 in the second DC modulation unit 150. When a current flows through the second heater electrodes 151, the second DC modulation unit 150 heats the fifth branched waveguides 120 by heat generated by the second heater electrodes 151. As a result, the thermo-optic effect changes the refractive indices of the fifth branched waveguides 120, so that it is possible to adjust the phases of the signal light beams propagating through the fifth branched waveguides 120. The second DC modulation unit 150 modulates the signal light beams propagating through the fifth branched waveguides 120, and outputs the modulated signal light beams to the second multiplexing unit 121. The second multiplexing unit 121 multiplexes the modulated signal light beams from the two fifth branched waveguides 120 in the second DC modulation unit 150, and outputs the multiplexed signal light beam to the first output waveguide 122.

The one second multiplexing unit 121 multiplexes the signal light beams from the two fifth branched waveguides 120 in the one second DC modulation unit 150, and outputs the multiplexed signal light beam to the one first output waveguide 122. The other second multiplexing unit 121 multiplexes the signal light beams from the two fifth branched waveguides 120 in the other second DC modulation unit 150, and outputs the multiplexed signal light beam to the other first output waveguide 122. The first output waveguide 122 is, for example, an Si waveguide that propagates the signal light beam from the second multiplexing unit 121.

The PR 124 polarization-rotates the signal light beam from the one second multiplexing unit 121 via the one first output waveguide 122, and outputs the polarization-rotated signal light beam to the PBC 125. The PBC 125 polarization-multiplexes the polarization-rotated signal light beam from the PR 124 and the signal light beam from the other second multiplexing unit 121 via the other first output waveguide 122, and outputs the polarization-multiplexed signal light beam to the optical fiber 103B on the output side of the optical fiber array 103.

By integrating the first DC modulation unit 140, the second DC modulation unit 150, the PR 124, and the PBC 125 on the SiPh chip 101, and mounting the thin film LN chip 102 on the SiPh chip 101 in the optical modulator 100, it is possible to miniaturize the chip size of the optical modulator 100. Furthermore, the optical axis of each of the optical fiber 103A on the input side and the optical fibers 103B on the output side in the optical fiber array 103, the PR 145, and the PBC 146 does not need to be adjusted, so that it is possible to reduce mounting cost.

However, in the optical modulator 100, the RF electrodes 132 of the thin film LN chip 102 are connected with the RF driver 133 via the electrode wires 126 on the SiPh chip 101. As a result, since Al is used for the electrode wires 126, propagation loss of the high-frequency signal becomes significant, and therefore a modulation band deteriorates. Moreover, loss per unit length of the waveguide of the SiPh chip 101 is significant, and therefore loss of light becomes significant.

Hence, an embodiment for dealing with such a situation will be described below as embodiment 1.

### Embodiment 1

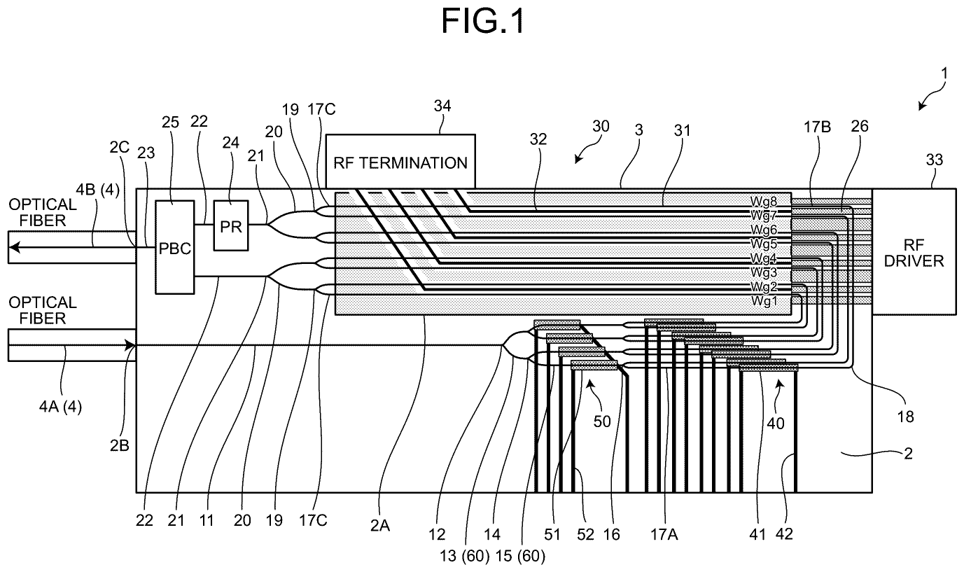

FIG. 1 is a schematic plan view illustrating an example of an optical modulator 1 according to embodiment 1. The optical modulator 1 illustrated in FIG. 1 includes an SiPh chip 2 that is a first chip on which first DC modulation units 40 each including first heater electrodes 41 and second DC modulation units 50 each including second heater electrodes 51 are mounted. The optical modulator 1 includes a thin film Lithium Niobate (LN: LiNbO₃) chip 3 that is a second chip on which an RF modulation units 30 each including RF electrodes 32 is mounted, and an optical fiber array 4 that includes an optical fiber 4A on an input side and an optical fiber 4B on an output side. The thin film LN chip 3 has a material having a higher electro-optic effect than that of the SiPh chip 2.

The SiPh chip 2 includes an Si substrate, an opening portion 2A that is opened at part of the Si substrate, a first port 2B that is disposed on one end surface, and a second port 2C that is disposed on one end surface. The opening portion 2A has a structure formed by digging part of the Si substrate by etching. The opening portion 2A is a portion at which the thin film LN chip 3 is mounted.

The SiPh chip 2 includes one first waveguide 11, one first branched portion 12, two first previous-stage branched waveguides 13, two second branched portions 14, and four second previous-stage branched waveguides 15. Note that the first previous-stage branched waveguides 13 and the second previous-stage branched waveguides 15 constitute a previous-stage branched waveguide 60. The SiPh chip 101 includes four third branched portions 16, eight first branched waveguides 17A, a turned-back parallel waveguide 18, and eight first parallel waveguides 17B. The first branched waveguides 17A constitute a subsequent-stage branched waveguide.

The SiPh chip 2 includes eight second branched waveguides 17C, four first multiplexing units 19, four third branched waveguides 20, two second multiplexing units 21, and two first output waveguides 22. The SiPh chip 2 includes one Polarization Rotator (PR) 24, one Polarization Beam Combiner (PBC) 25, and one second output waveguide 23.

The SiPh chip 2 includes the four first Direct Current (DC) modulation units 40 and the two second DC modulation units 50. The thin film LN chip 3 includes eight second parallel waveguides 31 and four radio frequency (RF) modulation units 30.

The first waveguide 11 in the SiPh chip 2 is, for example, an Si waveguide that propagates a signal light beam from the first port 2B. The input end of the first waveguide 11 is coupled with the optical fiber 4A on the input side in the optical fiber array 4. The first waveguide 11 outputs the signal light beam from the first port 2B to the first branched portion 12.

The first branched portion 12 branches the signal light beam from the first waveguide 11 into the two first previous-stage branched waveguides 13. The first previous-stage branched waveguides 13 are, for example, Si waveguides that propagate the signal light beam from the first branched portion 12. The first previous-stage branched waveguide 13 outputs the signal light beam from the first branched portion 12 to the second branched portion 14. The second branched portion 14 branches the signal light beam from the first previous-stage branched waveguide 13 into the two second previous-stage branched waveguides 15. The second previous-stage branched waveguides 15 are, for example, Si waveguides that propagate the signal light beam from the second branched portion 14. The second previous-stage branched waveguide 15 outputs the signal light beam from the second branched portion 14 to the third branched portion 16. The third branched portion 16 branches the signal light beam from the second previous-stage branched waveguide 15 into the two first branched waveguides 17A.

The first branched waveguides 17A are, for example, Si waveguides that propagate the signal light beam from the third branched portion 16. The first branched waveguide 17A outputs the signal light beam from the third branched portion 16 to the turned-back parallel waveguide 18. The turned-back parallel waveguide 18 is, for example, an Si waveguide that propagates the signal light beam from the first branched waveguide 17A. The turned-back parallel waveguide 18 outputs the signal light beam from the first branched waveguide 17A to the first parallel waveguide 17B. The first parallel waveguide 17B is, for example, an Si waveguide that propagates the signal light beam from the first branched waveguide 17A. The first parallel waveguide 17B is coupled with the second parallel waveguide 31 in the thin film LN chip 3.

The second DC modulation unit 50 includes the two second previous-stage branched waveguides 15 that are disposed in parallel, the second heater electrodes 51 that are disposed on the two second previous-stage branched waveguides 15, and electrode wires 52 that are electrically connected with the second heater electrodes 51. The two second previous-stage branched waveguides 15 are, for example, Si waveguides. The second DC modulation unit 50 is a phase adjustment unit that modulates signal light beams propagating through the two second previous-stage branched waveguides 15. When a current flows to the second heater electrode 51, the second DC modulation unit 50 heats the second previous-stage branched waveguides 15 by heat generated by the second heater electrode 51. As a result, the thermo-optic effect changes the refractive indices of the second previous-stage branched waveguides 15, so that it is possible to adjust the phases of the signal light beams propagating through the second previous-stage branched waveguides 15. The second DC modulation unit 50 modulates the signal light beams propagating through the second previous-stage branched waveguides 15, and outputs the modulated signal light beams to the third branched portions 16.

The first DC modulation unit 40 includes the two first branched waveguides 17A that are disposed in parallel, a plurality of the first heater electrodes 41 that are disposed in parallel on the two first branched waveguides 17A, and electrode wires 42 that are electrically connected with the first heater electrodes 41. The first DC modulation unit 40 is a phase adjustment unit that modulates the signal light beams propagating through the two first branched waveguides 17A. When a current flow through the first heater electrode 41, the first DC modulation unit 40 heats the first branched waveguides 17A by heat generated by the first heater electrode 41. As a result, the thermo-optic effect changes the refractive indices of the first branched waveguides 17A, so that it is possible to adjust the phases of the signal light beams propagating through the first branched waveguides 17A. The first DC modulation unit 40 modulates the signal light beams propagating through the first branched waveguides 17A, and outputs the modulated signal light beams to the first parallel waveguides 17B.

The RF modulation unit 30 is a phase modulation unit that modulates, at a high speed, signal light beams propagating through the second parallel waveguides 31 connected to the first parallel waveguides 17B. The RF modulation unit 30 includes the two second parallel waveguides 31 that are disposed in parallel, a plurality of the RF electrodes 32 that are disposed in parallel to the two second parallel waveguides 31, and an RF driver 33 that is a driver circuit that inputs a high-frequency signal to the RF electrodes 32. Furthermore, the RF modulation unit 30 includes an RF termination 34 that terminates the high-frequency signals of the RF electrodes 32. When high-frequency signals having bands of several 10 GHz are input from the RF driver 33 to the RF electrodes 32, for example, the RF modulation unit 30 can modulate the signal light beams propagating through the second parallel waveguides 31 at a high speed according to the high-frequency signals. The SiPh chip 2 includes electrode wires 26 that electrically connect the RF electrodes 32 and the RF driver 33 in the thin film LN chip 3. The RF modulation unit 30 modulates the signal light beams propagating through the second parallel waveguides 31 at the high speed, and outputs the signal light beams modulated at the high speed to the second branched waveguides 17C.

The optical modulator 1 includes eight branched waveguides Wg1 to Wg8 that constitute a Mach-Zehnder interferometer. Each branched waveguide is formed by connecting a waveguide of the first branched waveguide 17A, a waveguide of the turned-back parallel waveguide 18, a waveguide of the first parallel waveguide 17B, a waveguide of the second parallel waveguide 31, and a waveguide of the second branched waveguide 17C. In the Mach-Zehnder interferometer, the six branched waveguides Wg2 to Wg7 are disposed in parallel between the branched waveguide Wg1 on the inner circumferential side of the turned-back parallel waveguide 18 and the branched waveguide Wg8 on the outer circumferential side of the turned-back parallel waveguide 18.

The second branched waveguide 17C is coupled with the second parallel waveguide 31 in the RF modulation unit 30, and outputs the signal light beam modulated by the RF modulation unit 30 to the first multiplexing unit 19. The first multiplexing unit 19 multiplexes the signal light beams from the second branched waveguides 17C, and outputs the multiplexed signal light beam to the third branched waveguides 20. The second multiplexing unit 21 multiplexes the signal light beams from the respective third branched waveguides 20, and outputs the multiplexed signal light beams to the first output waveguides 22.

The one second multiplexing unit 21 multiplexes the signal light beams from the two third branched waveguides 20, and outputs the multiplexed signal light beam to the one first output waveguide 22. The other second multiplexing unit 21 multiplexes the signal light beams from the other two third branched waveguides 20, and outputs the multiplexed signal light beam to the other first output waveguide 22.

The PR 24 polarization-rotates the signal light beam from the one second multiplexing unit 21 via the one first output waveguide 22, and outputs the polarization-rotated signal light beam to the PBC 25. The PBC 25 polarization-multiplexes the polarization-rotated signal light beam from the PR 24 and the signal light beam from the other second multiplexing unit 21 via the other first output waveguide 22, and outputs the polarization-multiplexed signal light beam to the optical fiber 4B on the output side of the optical fiber array 4.

In the optical modulator 1 according to embodiment 1, the first DC modulation unit 40 and the second DC modulation unit 50 are disposed before an input stage of the turned-back parallel waveguide 18, and the RF modulation unit 30 is disposed after an output stage of the turned-back parallel waveguide 18, so that it is possible to miniaturize the chip size of the entire optical modulator 1.

In the optical modulator 1, the RF electrodes 32 of the thin film LN chip 3 are connected with the RF driver 33 via the electrode wires 26 on the SiPh chip 2, yet the electrode wires 26 on the SiPh chip 2 are made shorter than those in FIG. 5. As a result, it is possible to suppress degradation of a modulation band by reducing the propagation loss of the high-frequency signals and achieving speed matching between the high-frequency signals and the signal light beams. Moreover, although loss per unit length of the waveguide of the SiPh chip 2 increases, the waveguide length of the SiPh chip 2 can be shortened in a length direction of the SiPh chip 2, so that it is possible to reduce the loss of light.

The optical modulator 1 has the different waveguide lengths of the eight branched waveguides Wg1 to Wg8 that constitute the Mach-Zehnder interferometer, and therefore a situation is assumed that a phase difference of light is produced between the branched waveguides when the temperature changes, and output of the signal light beams becomes unstable. Hence, an embodiment for dealing with such a situation will be described below as embodiment 2.

### Embodiment 2

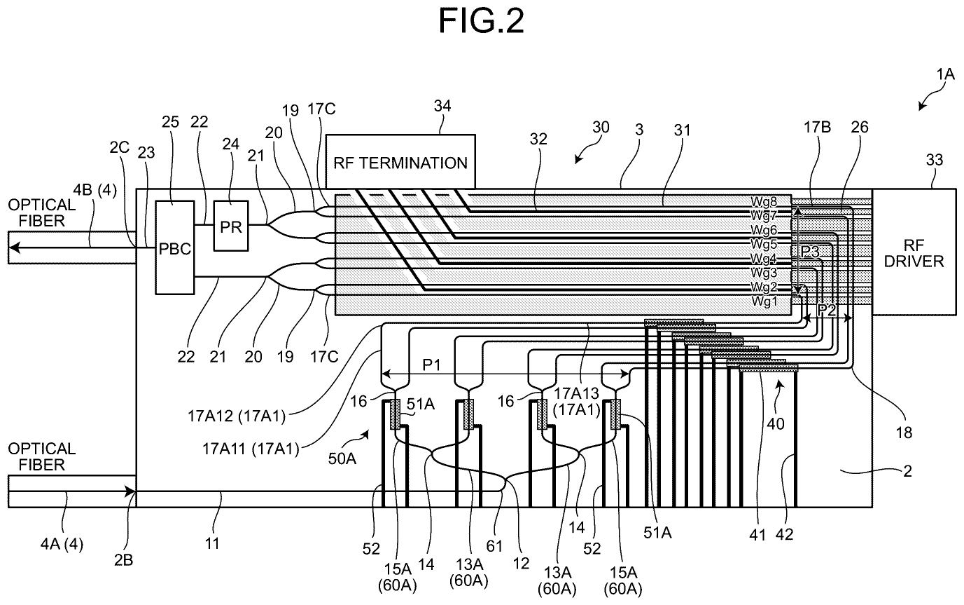

FIG. 2 is a schematic plan view illustrating an example of an optical modulator 1A according to embodiment 2. Note that the same components as those of an optical modulator 1 according to embodiment 1 are denoted by the same reference numerals, and the description of the overlapping components and operations will be omitted. The difference between the optical modulator 1A according to embodiment 2 and the optical modulator 1 according to embodiment 1 is that the optical modulator 1A includes a previous-stage branched waveguide 60A that is disposed in a direction substantially perpendicular to a first waveguide 11 and connects the first waveguide 11 and first branched waveguides 17A1.

The first waveguide 11 and the first branched waveguides 17A1 are disposed in parallel to second parallel waveguides 31. The previous-stage branched waveguide 60A includes two first previous-stage branched waveguides 13A that are connected with the first waveguide 11, and two second previous-stage branched waveguides 15A that are connected with the first previous-stage branched waveguides 13A. The previous-stage branched waveguide 60A is a waveguide that is connected with the first waveguide 11 and changes the traveling direction of the first waveguide 11. The two first branched waveguides 17A1 connected with the second previous-stage branched waveguides 15A are subsequent-stage branched waveguides that connect the previous-stage branched waveguide 60A and turned-back parallel waveguides 18 and return the traveling direction to an original traveling direction.

The first branched waveguide 17A1 includes a fourth branched waveguide 17A11 that is connected with the second previous-stage branched waveguide 15A, and a bent parallel waveguide 17A12 that has a bent structure connected with the fourth branched waveguide 17A11. The first branched waveguide 17A1 includes a parallel waveguide 17A13 that connects the bent parallel waveguide 17A12 and the turned-back parallel waveguide 18.

Eight branched waveguides Wg1 to Wg8 that constitute a Mach-Zehnder interferometer of the optical modulator 1A are waveguides between second branched portions 14 and first multiplexing units 19. Each branched waveguide is formed by connecting a waveguide of the first branched waveguide 17A1, a waveguide of the turned-back parallel waveguide 18, a waveguide of the first parallel waveguide 17B, a waveguide of the second parallel waveguide 31, and a waveguide of the second branched waveguide 17C. In the Mach-Zehnder interferometer, the six branched waveguides Wg2 to Wg7 are disposed in parallel between the branched waveguide Wg1 on the inner circumferential side of the turned-back parallel waveguide 18 and the branched waveguide Wg8 on the outer circumferential side of the turned-back parallel waveguide 18.

The optical modulator 1A has a first pitch P1 indicating a pitch interval between the fourth branched waveguide 17A11 (Wg1) on the inner circumferential side and the fourth branched waveguide 17A11 (Wg8) on the outer circumferential side among the plurality of fourth branched waveguides 17A11 that run in parallel. The optical modulator 1A has a second pitch P2 indicating a pitch interval between the turned-back parallel waveguide 18 (Wg1) on the inner circumferential side and the turned-back parallel waveguide 18 (Wg8) on the outer circumferential side among the plurality of turned-back parallel waveguides 18 that run in parallel. Furthermore, the optical modulator 1A has a third pitch P3 indicating a pitch interval between the first parallel waveguide 17B (Wg1) on the inner circumferential side and the first parallel waveguide 17B (Wg8) on the outer circumferential side among the plurality of first parallel waveguides 17B that run in parallel.

In a case of P1=P2=P3=0, no waveguide length difference is produced between the branched waveguides Wg1 to Wg8. That is, the difference between waveguide lengths of the branched waveguide Wg1 on the inner circumferential side and the branched waveguide Wg8 on the outer circumferential side is 0. Furthermore, in a case of P1=P2=0 and P3>0, the difference between waveguide lengths of the branched waveguide Wg1 on the inner circumferential side and the branched waveguide Wg8 on the outer circumferential side is −P3. That is, the waveguide length of the branched waveguide Wg8 is longer by P3 than the waveguide length of the branched waveguide Wg1. Furthermore, in a case of P1=P3=0 and P2>0, the difference between waveguide lengths of the branched waveguide Wg1 on the inner circumferential side and the branched waveguide Wg8 on the outer circumferential side is −2×P2. That is, the waveguide length of the branched waveguide Wg8 is longer by 2×P2 than the waveguide length of the branched waveguide Wg1. Furthermore, in a case of P2=P3=0 and P1>0, the difference between waveguide lengths of the branched waveguide Wg1 on the inner circumferential side and the branched waveguide Wg8 on the outer circumferential side is P1. That is, the waveguide length of the branched waveguide Wg1 is longer by P1 than the waveguide length of the branched waveguide Wg8. Consequently, by setting P1=2×P2+P3, it is possible to equalize the lengths of the waveguide length of the branched waveguide Wg1 and the waveguide length of the branched waveguide Wg8. It is also possible to equalize the waveguide lengths of the other branched waveguides Wg2 to Wg7 by setting the same relationship. Furthermore, the condition that the turned-back parallel waveguides 18 become short and the electrode wires 26 on the SiPh chip 2 can be shortened is P3>P2. To equalize the waveguide lengths of the branched waveguides Wg1 to Wg8, P1>P3 is set.

Furthermore, in the optical modulator 1A, the fourth branched waveguide 17A11, the turned-back parallel waveguide 18, and the first parallel waveguide 17B are disposed such that the relationship between values of P1>P3>P2 is satisfied. As a result, the waveguide lengths of the eight branched waveguides constituting the Mach-Zehnder interferometer become equal, so that, even when the temperature changes, there is no phase difference of light between the waveguides in the branched waveguides, and it is possible to stabilize output of signal light beams.

The second DC modulation unit 50A includes a second heater electrode 51A that is disposed for each waveguide in the second previous-stage branched waveguide 15A and applies a direct current electrical signal to the second DC modulation unit 50A, and each second heater electrode 51A is disposed in parallel to a direction substantially perpendicular to the first waveguide 11.

In the optical modulator 1A according to embodiment 2, the fourth branched waveguide 17A11, the turned-back parallel waveguide 18, and the first parallel waveguide 17B are disposed such that the relationship between the values of P1>P3>P2 is satisfied. As a result, the waveguide lengths of the eight branched waveguides Wg1 to Wg8 constituting the Mach-Zehnder interferometer become equal, so that, even when the temperature changes, there is no phase difference of light between the waveguides in the branched waveguides, and it is possible to stabilize output of signal light beams.

Furthermore, the case has been exemplified where the fourth branched waveguide 17A11, the turned-back parallel waveguide 18, and the first parallel waveguide 17B are disposed in the optical modulator 1A according to embodiment 2 such that the relationship between the values of P1>P3>P2 is satisfied. However, the present invention is not limited thereto. As described above, the fourth branched waveguide 17A11, the turned-back parallel waveguide 18, and the first parallel waveguide 17B may be disposed in the optical modulator 1A such that the relationship of (P1=P2×2+P3) is satisfied. Even in this case, the waveguide lengths of the eight branched waveguides constituting the Mach-Zehnder interferometer become equal, so that, even when the temperature changes, there is no phase difference of light between the waveguides in the branched waveguides, and it is possible to stabilize output of signal light beams.

In the optical modulator 1A according to embodiment 2, the second previous-stage branched waveguide 15A between the second branched portion 14 and a third branched portion 16 is disposed in the direction substantially perpendicular to the first waveguide 11, and the second heater electrode 51A in the second DC modulation unit 50A is disposed on the second previous-stage branched waveguide 15A. However, by disposing the second heater electrode 51A on the second previous-stage branched waveguide 15A, the chip size of the optical modulator 1A in the direction perpendicular to the first waveguide 11 becomes large. Hence, an embodiment for dealing with such a situation will be described below as embodiment 3.

### Embodiment 3

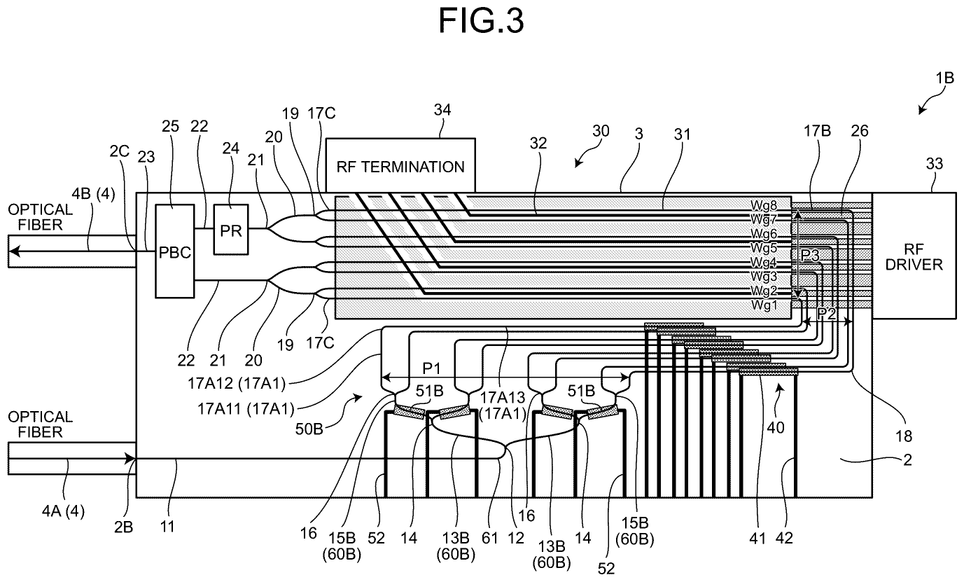

FIG. 3 is a schematic plan view illustrating an example of an optical modulator 1B according to embodiment 3. Note that the same components as those of an optical modulator 1A according to embodiment 2 are denoted by the same reference numerals, and the description of the overlapping components and operations will be omitted. The difference between the optical modulator 1B according to embodiment 3 and an optical modulator 1A according to embodiment 2 is that second previous-stage branched waveguides 15B are not disposed in the direction perpendicular to a first waveguide 11, but is disposed in a direction substantially parallel to the first waveguide 11. The optical modulator 1B includes previous-stage branched waveguides 60B between the first waveguide 11 and first branched waveguides 17A1.

The previous-stage branched waveguide 60B includes two first previous-stage branched waveguides 13B that are connected with the first waveguide 11, and the two second previous-stage branched waveguides 15B that are connected with the first previous-stage branched waveguides 13B. The previous-stage branched waveguide 60B is a waveguide that is connected with the first waveguide 11 and changes the traveling direction of the first waveguide 11. The two first branched waveguides 17A1 connected with the second previous-stage branched waveguides 15B are subsequent-stage branched waveguides that connect the previous-stage branched waveguides 60B and turned-back parallel waveguides 18 and return the traveling direction to the original traveling direction.

The first branched waveguide 17A1 includes a fourth branched waveguide 17A11 that is connected with the second previous-stage branched waveguide 15B, and a bent parallel waveguide 17A12 that has a bent structure connected with the fourth branched waveguide 17A11. The first branched waveguide 17A1 includes a parallel waveguide 17A13 that connects the bent parallel waveguide 17A12 and the turned-back parallel waveguide 18.

A second DC modulation unit 50B includes a second heater electrode 51B that is disposed for each waveguide in the second previous-stage branched waveguide 15B and applies a direct current electrical signal to the second DC modulation unit 50B, and each second heater electrode 51B is disposed in parallel to a direction substantially parallel to the first waveguide 11.

In the optical modulator 1B according to embodiment 3, each second heater electrode 50B of the second DC modulation unit 51B disposed for each waveguide in the second previous-stage branched waveguide 15B is disposed in parallel to the direction substantially parallel to the first waveguide 11. As a result, it is possible to reduce the chip size of the optical modulator 1B in the direction perpendicular to the first waveguide 11.

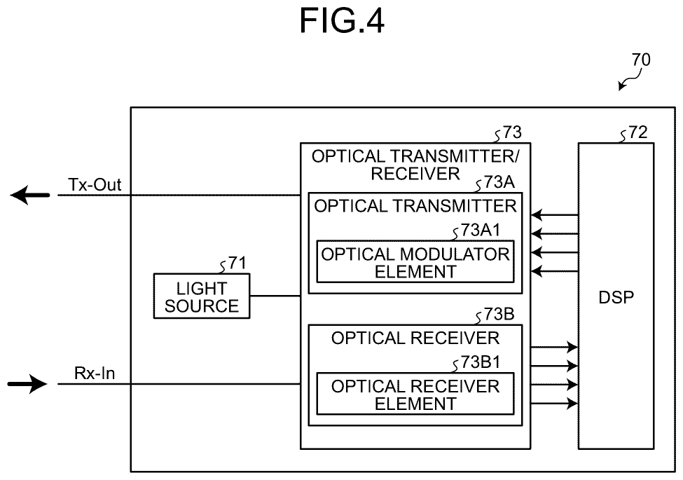

FIG. 4 is an explanatory view illustrating an example of an optical transceiver 70 according to the present embodiment. The optical transceiver 70 illustrated in FIG. 4 is connected with an optical fiber on the output side and an optical fiber on the input side. The optical transceiver 70 includes a light source 71, a Digital Signal Processor (DSP) 72, and an optical transmitter/receiver 73. The optical transmitter/receiver 73 includes an optical transmitter 73A and an optical receiver 73B. The DSP 72 is an electrical component that executes digital signal processing. The DSP 72 executes, for example, processing such as encoding of transmission data, generates an electrical signal including the transmission data, and outputs the generated electrical signal to the optical transmitter 73A. Furthermore, the DSP 72 acquires an electrical signal including received data from the optical receiver 73B, executes processing such as decoding of the acquired electrical signal, and obtains the received data.

The light source 71 includes, for example, a laser diode or the like, generates light of a predetermined wavelength, and supplies the light to the optical transmitter 73A and the optical receiver 73B. The optical transmitter 73A includes an optical modulator element 73A1 that modulates light supplied from the light source 71 by the electrical signal output from the DSP 72, and outputs the modulated signal light beam to the optical fiber.

The optical modulator element 73A1 includes a first chip that includes a first port and a second port, and a second chip that is disposed on the first chip and has a material having a higher electro-optic effect than that of the first chip. The first chip includes a first waveguide that is connected with the first port and propagates a signal light beam from the first port, and a first branched waveguide that is connected with the first waveguide and has a branched structure that propagates the signal light beam from the first waveguide. The first chip includes a turned-back parallel waveguide that is connected with the first branched waveguide and has a turned-back structure, and a first parallel waveguide that is connected with the turned-back parallel waveguide and propagates the signal light beam from the turned-back parallel waveguide. The first chip includes a second waveguide that is connected with the second port and propagates the signal light beam to the second port, and a second branched waveguide that is connected with the second waveguide and has a branched structure that propagates the signal light beam to the second waveguide. The first chip includes a phase adjustment unit that is disposed on the first branched waveguide, and adjusts the phase of the signal light beam propagating through the first branched waveguide according to a direct current electrical signal. The second chip includes a second parallel waveguide that is coupled with the first parallel waveguide on a first end surface and is coupled with the second branched waveguide on a second end surface different from the first end surface. The second parallel waveguide propagates a signal light beam from the first parallel waveguide to the second branched waveguide. The second chip includes a phase modulation unit that is disposed on the second parallel waveguide, and modulates the phase of the signal light beam propagating through the second parallel waveguide according to a high-frequency signal.

When the light supplied from the light source 71 propagates through the waveguide, the optical transmitter 73A generates a signal light beam by modulating this light using an electrical signal. The optical receiver 73B includes an optical receiver element 73B1 that receives received light from the optical fiber, converts the received light into an electrical signal using the light supplied from the light source 71, and outputs the converted electrical signal to the DSP 72.

Although the case has been exemplified where the optical transmitter 73A and the optical receiver 73B are built in the optical transceiver 70, the present invention is also applicable to an optical transmitter including only the built-in optical transmitter 73A including a built-in optical device. Furthermore, the optical device is applicable not only to the optical transceiver 70, but also to the optical transmitter/receiver 73.

Note that, for convenience of description, the case has been exemplified where, in the optical modulator 1 according to the embodiment, arrangement is made to achieve a route of a first port 2B→the first waveguide 11→a second DC modulation unit 50→a first DC modulation unit 40→the turned-back parallel waveguide 18→an RF modulation unit 30 of a thin film LN chip 3→a PBC 25→a second port 2C. However, the present invention is not limited thereto, and arrangement may be made to achieve a route of the first port 2B→the first waveguide 11→the RF modulation unit 30 of the thin film LN chip 3→the turned-back parallel waveguide 18→the first DC modulation unit 40→the second DC modulation unit 50→the PBC 25→the second port 2C.

Furthermore, although the case has been exemplified where the phase adjustment units are configured as the first DC modulation units 40 and the second DC modulation units 50, the phase adjustment units are not limited thereto, and may be any one of the first DC modulation units 40 and the second DC modulation units 50, and can be appropriately changed. Furthermore, the case has been exemplified where the first DC modulation units 40 and the second DC modulation units 50 use the heater electrodes, electrodes to which a bias voltage is applied may be used, and electrodes can be appropriately changed.

Although the thin film LN chip has been exemplified in the present embodiment, the present invention is not limited thereto, and for example, TF-Barium Titanate may be used, and materials can be appropriately changed. The material of the electro-optic effect may be, for example, TF-BTO (BaTiO₃), TF-PLZT (PbLaZrTiO₃), or TF-PZT (PbZrTiO₃), and can be appropriately changed.

In the present embodiment, the material of the electrode wires is not limited to Al, Au, Cu, or the like, and can be appropriately changed.

According to one aspect, it is possible to provide an optical device or the like having a miniaturized chip size.

All examples and conditional language recited herein are intended for pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although the embodiments of the present invention have been described in detail, it should be understood that the various changes, substitutions, and alterations could be made hereto without departing from the spirit and scope of the invention.

What is claimed is:

1. An optical device comprising:
a first chip that includes a first port and a second port; and
a second chip that is disposed on the first chip and has a material having a higher electro-optic effect than an electro-optic effect of the first chip, wherein
the first chip includes
a first waveguide that is connected with the first port and propagates a signal light beam from the first port,
a first branched waveguide that is connected with the first waveguide and has a branched structure that propagates the signal light beam from the first waveguide,
a turned-back parallel waveguide that is connected with the first branched waveguide and has a turned-back structure,
a first parallel waveguide that is connected with the turned-back parallel waveguide and propagates the signal light beam from the turned-back parallel waveguide,
a second waveguide that is connected with the second port and propagates the signal light beam to the second port,
a second branched waveguide that is connected with the second waveguide and has a branched structure that propagates the signal light beam to the second waveguide, and
a phase adjustor that is disposed on the first branched waveguide and adjusts a phase of the signal light beam propagating through the first branched waveguide according to a direct current electrical signal, and
the second chip includes
a second parallel waveguide that is coupled with the first parallel waveguide on a first end surface, is coupled with the second branched waveguide on a second end surface different from the first end surface, and propagates the signal light beam from the first parallel waveguide to the second branched waveguide, and
a phase modulator that is disposed on the second parallel waveguide, and modulates a phase of the signal light beam propagating through the second parallel waveguide according to a high-frequency signal.

2. The optical device according to claim 1, wherein
the first chip includes
an electrode wire that is disposed in parallel to the first parallel waveguide and electrically connects an electrode in the phase modulator and a driver circuit.

3. The optical device according to claim 1, wherein
the first branched waveguide includes
a previous-stage branched waveguide that is connected with the first waveguide and changes a traveling direction of the first waveguide, and
a subsequent-stage branched waveguide that connects the previous-stage branched waveguide and the turned-back parallel waveguide and returns a traveling direction to an original traveling direction.

4. The optical device according to claim 3, wherein
the previous-stage branched waveguide includes
a plurality of first previous-stage branched waveguides that are connected with the first waveguide, and
a second previous-stage branched waveguide that is connected with the first previous-stage branched waveguide,
the subsequent-stage branched waveguide includes
a fourth branched waveguide that is connected with each waveguide in the second previous-stage branched waveguide, and
a parallel waveguide that connects between the fourth branched waveguide and the turned-back parallel waveguide, and includes
a first pitch that indicates a pitch interval between fourth branched waveguides at both ends among a plurality of the fourth branched waveguides that run in parallel,
a second pitch that indicates a pitch interval between turned-back parallel waveguides at both ends among a plurality of the turned-back parallel waveguides that run in parallel, and
a third pitch that indicates a pitch interval between first parallel waveguides at both ends among a plurality of the first parallel waveguides that run in parallel, and
the first pitch, the second pitch, and the third pitch satisfy a relationship of (the first pitch>the third pitch>the second pitch).

5. The optical device according to claim 3, wherein
the previous-stage branched waveguide includes
a plurality of first previous-stage branched waveguides that are connected with the first waveguide, and
a second previous-stage branched waveguide that is connected with the first previous-stage branched waveguide,
the subsequent-stage branched waveguide includes
a fourth branched waveguide that is connected with each waveguide in the second previous-stage branched waveguide, and
a parallel waveguide that connects between the fourth branched waveguide and the turned-back parallel waveguide, and includes
a first pitch that indicates a pitch interval between fourth branched waveguides at both ends among a plurality of the fourth branched waveguides that run in parallel,
a second pitch that indicates a pitch interval between turned-back parallel waveguides at both ends among a plurality of the turned-back parallel waveguides that run in parallel, and
a third pitch that indicates a pitch interval between first parallel waveguides at both ends among a plurality of the first parallel waveguides that run in parallel, and
the first pitch, the second pitch, and the third pitch satisfy a relationship of (the first pitch=the second pitch×2+the third pitch).

6. The optical device according to claim 4, wherein
the phase adjustor includes
an electrode that is disposed on each waveguide in the second previous-stage branched waveguide, and applies the direct current electrical signal to the phase adjustor, each electrode being disposed in parallel to a direction substantially perpendicular to the first waveguide.

7. The optical device according to claim 5, wherein
the phase adjustor includes
an electrode that is disposed on each waveguide in the second previous-stage branched waveguide, and applies the direct current electrical signal to the phase adjustor, each electrode being disposed in parallel to a direction substantially perpendicular to the first waveguide.

8. The optical device according to claim 4, wherein
the second previous-stage branched waveguide is
disposed substantially parallel to the first waveguide, and
the phase adjustor includes
an electrode that is disposed on each waveguide in the second previous-stage branched waveguide, and applies the direct current electrical signal to the phase adjustor, each electrode being disposed in parallel to a direction substantially parallel to the first waveguide.

9. The optical device according to claim 5, wherein
the second previous-stage branched waveguide is
disposed substantially parallel to the first waveguide, and
the phase adjustor includes
an electrode that is disposed on each waveguide in the second previous-stage branched waveguide, and applies the direct current electrical signal to the phase adjustor, each electrode being disposed in parallel to a direction substantially parallel to the first waveguide.

10. An optical transmitter comprising:
a light source that emits light; and
an optical modulator element that modulates the light from the light source according to an electrical signal, wherein
the optical modulator element includes
a first chip that includes a first port and a second port, and
a second chip that is disposed on the first chip and has a material having a higher electro-optic effect than an electro-optic effect of the first chip,
the first chip includes
a first waveguide that is connected with the first port and propagates a signal light beam from the first port,
a first branched waveguide that is connected with the first waveguide and has a branched structure that propagates the signal light beam from the first waveguide,
a turned-back parallel waveguide that is connected with the first branched waveguide and has a turned-back structure,
a first parallel waveguide that is connected with the turned-back parallel waveguide and propagates the signal light beam from the turned-back parallel waveguide,
a second waveguide that is connected with the second port and propagates the signal light beam to the second port,
a second branched waveguide that is connected with the second waveguide and has a branched structure that propagates the signal light beam to the second waveguide, and
a phase adjustor that is disposed on the first branched waveguide and adjusts a phase of the signal light beam propagating through the first branched waveguide according to a direct current electrical signal, and
the second chip includes
a second parallel waveguide that is coupled with the first parallel waveguide on a first end surface, is coupled with the second branched waveguide on a second end surface different from the first end surface, and propagates the signal light beam from the first parallel waveguide to the second branched waveguide, and
a phase modulator that is disposed on the second parallel waveguide, and modulates a phase of the signal light beam propagating through the second parallel waveguide according to a high-frequency signal.

11. An optical transceiver comprising:
a processor that performs signal processing on an electrical signal;
a light source that produces light;
an optical transmitter that modulates the light generated from the light source using an electrical signal output from the processor; and
an optical receiver that converts received light into an electrical signal using the light generated from the light source, wherein
the optical transmitter includes
a first chip that includes a first port and a second port, and
a second chip that is disposed on the first chip and has a material having a higher electro-optic effect than an electro-optic effect of the first chip,
the first chip includes
a first waveguide that is connected with the first port and propagates a signal light beam from the first port,
a first branched waveguide that is connected with the first waveguide and has a branched structure that propagates the signal light beam from the first waveguide,
a turned-back parallel waveguide that is connected with the first branched waveguide and has a turned-back structure,
a first parallel waveguide that is connected with the turned-back parallel waveguide and propagates the signal light beam from the turned-back parallel waveguide,
a second waveguide that is connected with the second port and propagates the signal light beam to the second port,
a second branched waveguide that is connected with the second waveguide and has a branched structure that propagates the signal light beam to the second waveguide, and
a phase adjustor that is disposed on the first branched waveguide and adjusts a phase of the signal light beam propagating through the first branched waveguide according to a direct current electrical signal, and
the second chip includes
a second parallel waveguide that is coupled with the first parallel waveguide on a first end surface, is coupled with the second branched waveguide on a second end surface different from the first end surface, and propagates the signal light beam from the first parallel waveguide to the second branched waveguide, and
a phase modulator that is disposed on the second parallel waveguide, and modulates a phase of the signal light beam propagating through the second parallel waveguide according to a high-frequency signal.
